(19) United States
(12) Patent Application Publication
(10) Pub. No.: US 2002/0031597 A1
(43) Pub. Date: Mar. 14, 2002

(54) Soybean products and methods

(76) Inventor: Arthur Stark, Bothell, WA (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/828,333

(22) Filed: Apr. 5, 2001

Related U.S. Application Data
(60) Provisional application No. 60/194,997, filed on Apr. 5, 2000.

(51) Int. Cl. A23L 1/36

(52) U.S. Cl. 426/629

(57) ABSTRACT

An edible soybean product, with no off odors, bad taste, or after taste, produced from a processed whole soybean or splits with the hull and hypocotyl removed and in the form of halves [splits], bits, and/or flour and also fortified food products at a higher level than conventional non processed soybeans, soybean flour, soybean halves, or soybean bits.

### BACKGROUND OF THE INVENTION

A) Field of the Invention

The present invention has several embodiments. First it relates to a process for producing a soybean snack made from soybean splits with the hypocotyis and the hulls removed. After processing, these snacks are ready to eat in their original split form without a beanie, astringent flavor, grainy texture and flatulence. The halves/splits are sold as a nutritious snack. In another embodiment the splits/halves can be milled for combination use in the flour form and the nugget [bits] form in bakery products: bread, rolls buns, muffins, cookies, biscuits, and other bakery formulations where in the prior art soy cannot be used in bakery products above 10% because of the beanie flavor and odor of unprocessed soybeans, soy isolate or soy concentrate proteins. Also in the prior art they cannot be used in bakery items above 7% because they produce low volume. In the present invention the flour can be used to raise the flavor profile in protein drinks, smoothies, and meal supplements. Also in the present invention, because of their good taste the splits and/or bits can be used for toppings, salads, ice cream and frozen desserts.

B) Background Art

When the components of taste and flavor of an unprocessed soybean is expressed as a snack, in the prior art processes there is a disagreeable unripe odor simultaneously with an off beanie flavor and taste. In the present invention to create an ideal soybean snack, the process starts by utilizing the soybean with the hypocotyl and hull removed. It is necessary that the components of taste and flavor of soybean material with the disagreeing unripe odor and taste characteristic of soybean be removed to retain the flavorful soybean taste characteristic of soybeans.

The oligosaccharides, raffinose and stachyose are present in soybeans. The concentration of these oligosaccarides are an important consideration in developing a soy snack because humans have difficulty digesting these naturally occurring carbohydrates. Through our process we inhibit raffinose which is present naturally in soybeans in concentrations of less than 1%, and stachyose which is present in concentrations of about 3% to 5% by total weight of the dry soybean. Humans lack the enzyme alphaglactosidase necessary to hydrolyze the alpha-galactosyl linkages present in raffinose and stacyose to simpler sugars which are absorbable. Instead, the compounds enter the lower intestinal tract fully intact, where they are metabolized by bacteria and actually ferment to produce flatulence and intestinal gas. As a result, no digestible nutrients are obtained and considerable discomfort can result.

Palatability or flavor is an important consideration because the natural flavor of a soybean is considered to be an off flavor or beany flavor due primarily to the activity of the enzyme lipoxygenase. Lipoxygenase is comprised of three isoenzymes known as lipooxygenase-1, lipoxygenase-2, and lipoxygense 3. It is clear that he beany or painty flavor of soybeans is due in large part to lipoxygenase catalyzed oxidation of linoleic and linolenic fatty acids in the 20% oil content of the soybean. The process of the present invention includes blanching the clean soybean halves which partially deactivate the lipoxygense enzyme. There are numerous other considerations relevant to composition and nutrient content of soy products. Such considerations include the presence of trypsin inhibitors which inhibit the digestion of proteins and hemaggiutinins, and which we minimize through our microwave process as they otherwise exert negative effects on the nutritional quality of soybean protein.

Our process does not exclude goitrogens, the antivitamins D, E, and B12, as well as isoflavones, phytoestrogens, saponins, and traces of other vitamins and minerals. Research continues regarding other nutritional and biochemical effects of these elements in soybeans which include its cholesterol lowering ability as a phytoestrogen and as a possible anitcarcinogen. Of the isoflavones contained in soybeans, two—genistein and daidzein—seem to hold the most promise from recent studies. Soy is the most concentrated food source of genistein, the isoflavone that has been highlighted for its role as to its effectiveness in the prevention of breast and prostate cancer. Genistein as a phytoestrogen has been used to help relieve hot flashes as well as PMS and osteoporosis. While studies have not been conducted to determine whether one isoflavone is more beneficial than the other, many beneficial effects have been reported for genistein, while relatively few have heralded the benefits of daidzein. The raw soybean typical analysis is: 53% total genistein, 38% total daidzein and 9% total glycitein. Our process causes the total genistein to raise to approximately 71%; the total daidzein is raised to approximately 29%; and the total glycitein is lowered to approximately 0%.

### SUMMARY OF THE INVENTION

The present invention comprises a method of processing soybeans to provide an improved soybean product, and also the product itself.

Broadly, the method of the present invention comprises first providing soybeans in a relatively dry state. Then the soybeans are blanched for a period of time in hot water, after which they are soaked in cold water. This is followed by a heating and drying of the soybeans to form the improved soybean product. In one embodiment the end product is in the form of soybean particles of larger size, such as whole beans or halves.

In another embodiment, the soybean product is roasted subsequent to being bleached in hot water and reduced in particle size to form roasted soy bits which can be used for products such as those used in baking and food products.

In another version, the soybean product is reduced to a flour like particle size so as to be baking and food products.

In a preferred form, prior to blanching the soybeans they are subjected to a milling and separation process for removing the hull and hypocotyl from the soybeans and thence processing the relatively pure soybean further by blanching.

The soybeans are blanched generally at temperatures between 70° C. to 100° C. with a narrow range being 80° C. to 90° C. The soybeans are soaked in cold water for at least one hour, and more desirably at least two hours.

The soybeans that are soaked in cold water are thereafter heated at a temperature greater than 212° F., and in one embodiment can be roasted, such as in a rotary drum, of a temperature of at least 400° F. The moisture level of the soybeans that are subjected to blanching are broadly within a range of moisture level between 2% to 6%, more desirably between 3% to 5%. The soybeans are soaked in cold water for at least one hour, and desirably for two hours, up to as much as four hours. Also, the milling and separation can be accomplished by processing the soybeans through a ripple mill for removing the hull, splitting the soybean, and removal of hypocotyl and passing the result in material through a sifter.

Also, the present invention comprises an improved soybean product having the various particle sizes as described above. More specifically, the flour like product that is produced from the soybeans has a particle size range from 400 microns to 50 microns. Other features will become apparent from the following detailed description.

### BRIEF DESCRIPTION OF THE DRAWINGS:

FIG. 1 is a schematic drawing illustrating the method of the present invention.

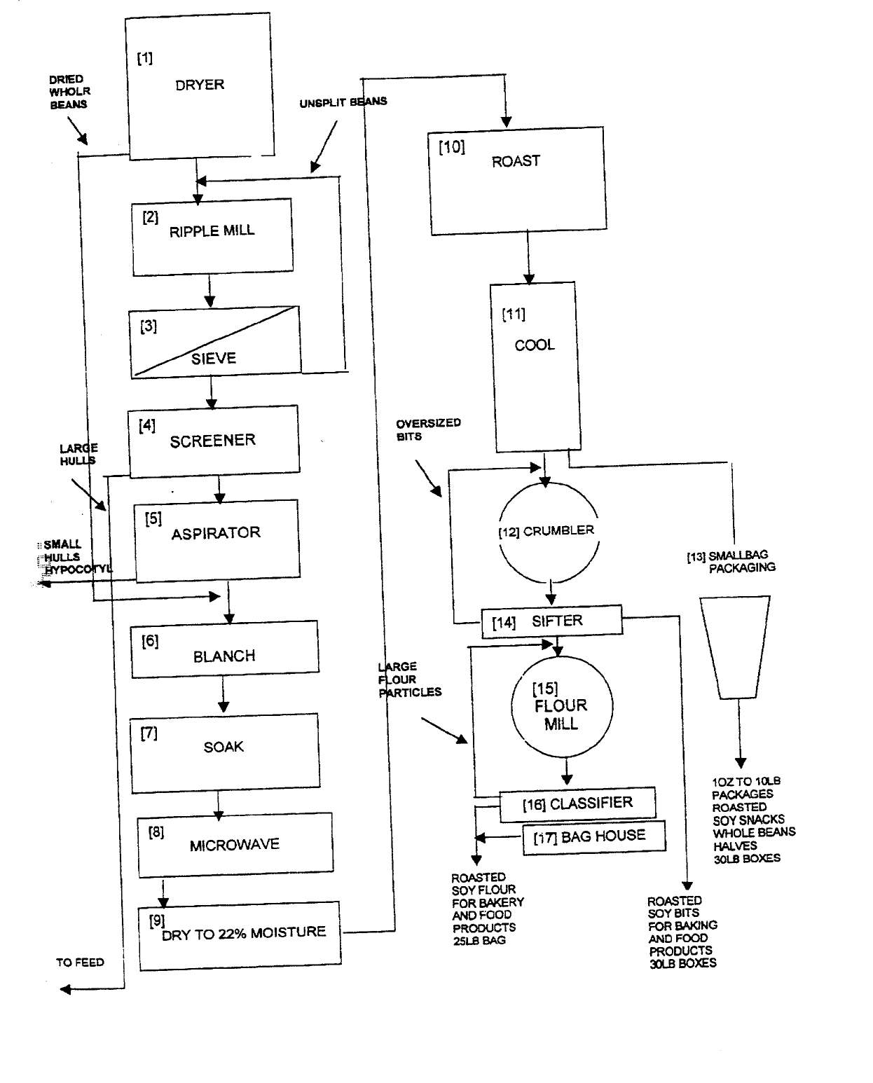

### DETAILED DESCRIPTION OF THE PREFERRED EMBODIMENTS

The present invention will be illustrated in detail hereinafter. Cleaned certified [identity preserved] whole soybeans at 11% to 14.5% moisture are received and documented. Step 1: the soybeans are dried in a conventional grain dryer at 140° F. until they reach a moisture level of 4%. In step 2.1 the whole beans go from the dryer at 4% moisture directly to Step 6 [blanch]. In an alternative step 2.2 these whole beans at 4% moisture that are going to be snacks from the soybean halves, flour, and bit through a Ripple Mill. This is a mill specially designed for removing the hull, splitting the whole soybean, and removal of hypocotyl. From the Ripple Mill the soybeans pass through Step 3 a Rotex type sifter with a slotted screen where the unsplit whole soybeans return to the Ripple Mill for splitting (Step 2.2) and the splits, hulls, and hypocotyl go through Step 4 which utilizes a rotary screener that has a screen sized to remove the large hulls. The small hulls, hypocotyl, and splits then go through Step 5 which utilizes a four channel aspirator that uses an air system which removes the last of the small hulls and the hypocotyl which are sent for further processing. Step 6: the totally cleaned soybeans halves [splits] or the whole beans are next blanched in water above 85° C. for 15 to 30 minutes. You must not use presoaked soybeans because the dormant state of soybeans are changed toward an activated state and a bad taste is caused due to activation of enzymes in the soybeans. In the present invention when soybeans are used without presoaking with water (which would cause swelling by water absorption), when these are blanched at over 85° C. for 15 to 30 minutes, enzymes which cause a bad taste are quickly inactivated and it is possible to minimize the formation of a bad taste. When carrying out the blanching process an alkali [sodium bicarbonate] can be added to the water in a concentration of 0.01 to 2% by weight. This can inhibit the activity of the B-glucosidase which has higher thermal resistance. This helps the product in its softness and mouth feel. Step 7: the halves/soybeans are drained of water and then soaked in cold water up to 4 hours before going through Step 8 a microwave process at 915 Mhz for 5 minutes. Step 9: the beans/halves are then dried to 22% moisture through an infrared belt oven at 250° F. Step 10: the beans/halves are roasted in a rotary drum air oven at 400° F. for 1.5 minutes. Step 11: the beans/halves go through a 30-minute cooling tunnel that uses fans with ambient air. Step 12: the beans/halves are then processed in a crumbler to reduce the particle size. In one alternative step the beans/halves from the cooling tunnel go through Step 13 to a form, fill, and seal packager for retail packages. Then in a second alternative step (11.2) the halves go from the cooling tunnel to a roller mill [crumbler] to break the halves into bits. In Step 14 the bits go from the crumbler into a Sweco type shaker sifter with a #10 mesh screen and a #14 mesh screen. All the bits that do not go through the #10 mesh screen are returned to the crumbler and the bits that go through the #10 mesh screen but not through the #14 mesh screen are packaged for sale. The product that goes through the #14 screen goes to Step 15 the Raymond mill where it is milled and then Step 16 classified to various sized from 400 microns to 50 microns. The smaller soy flour particles Step 17 will go to the bag house collector and then be bagged with the larger soy flour particles.

The moisture content of the soybeans dried in step 1 could possibly be 3.5%, 4.5%, 3.0% to 5%, or 2% to 6%, with the preferred value being 4%.

The bleaching of the soybeans can be accomplished in water that is in a temperature of at least about 70° C., 75° C., 80° C., or 85° C., and can possibly go up to a temperature from 90° C., 95° C. or 100° C.

Also, the time for the blanching could be broadly between ten minutes to one hour, or within such limits as at least at or above fifteen minutes, twenty, twenty-five or thirty minutes, or up to as high as thirty five, forty, forty-five, fifty, fifty-five or sixty minutes.

Also, in step 8, the soybeans could be microwave processed between one and fifteen minutes, or at increments at least as high as 2, 3, 4, or 5 minutes, or up to time periods of 6, 7, 8, 9, 10, 11, 12, 13, 14 or 15 minutes.

The drying step 9 could be from at a temperature of the boiling point of water, up to 225° F., 220° F., 300° F. or 350° F. Further, the roasting of step 10 could be accomplished at temperatures from 250° F., 300° F., 350° F., up to 450° F., 500° F., or 550° F.

It is obvious that various modifications could be made without departing from the basic teachings thereof.

Therefore I claim:

1. A method of processing soybeans to provide an improved soybean product, comprising:
a) providing soybeans in a relatively dry state;
b) blanching the soybeans in hot water;
c) soaking the soybeans in cold water;
d) heating and drying the soybeans to form the improved soybean product.

2. The method as recited in claim 1, wherein the improved soybean product produced by claim 1 is provided in the form of soybean particles of larger size, such as whole beans or halves.

3. The method as recited in claim 1, wherein the improved soybean product is roasted subsequent to being blanched in hot water and reduced in particle size to form roasted soy bits, which can be used for products, such as those used in baking and food products.

4. The method as recited in claim 1, wherein said improved soybean product is reduced to a flour like particle size so as to be useable in bakery and food products.

5. The method as recited in claim 1, wherein prior to blanching, the soybeans are subjected to a milling and separation process for removing the hull and the hypocotyl from the soybeans and thence processing the relatively pure soybean further by blanching.

6. The method as recited in claim 5, further comprising splitting a substantial portion of the soybeans prior to blanching.

7. The method as recited in claim 6, wherein said milling and separation is accomplished by processing the soybeans through a ripple mill for removing the hull, splitting the soybean, and removal of hypocotyl and passing the resulting material through a sifter to return unsplit soybeans to the ripple mill and then utilizing a further separation process by means of an aspirating air stream.

8. The method as recited in claim 1, wherein the soybeans that are soaked in cold water are thereafter heated at a temperature greater than the 212° F.

9. The method as recited in claim 8, wherein said soybean product after being subjected to heat at above 212° F. is roasted, such as in a rotary drum air oven at a temperature of at least approximately 400° F.

10. The method as recited in claim 1, wherein the moisture level of the soybeans which are subjected to the blanching are at a moisture level of between 2% and 6%.

11. The method as recited in claim 10, wherein said moisture level is between about 3% to 5%.

12. The method as recited in claim 10, wherein the soybeans are blanched in water that is between 70° C. to 100° C.

13. The method as recited in claim 12, wherein said temperature at which the beans are blanched are between about 80° C. to 90° C.

14. The method as recited in claim 1, wherein the soybeans are soaked in cold water for at least one hour.

15. The method as recited in claim 14, wherein the soybeans are soaked in cold water for at least two hours.

16. A soybean product made in accordance with the method of claim 1, wherein after the soybean product has been soaked in cold water, heated and cooled, it is in a particle size of whole soybeans and/or soybean halves.

17. A product made in accordance with claim 1, wherein the soybeans that have been soaked, heated and cooled are then reduced in particle size, suitable for use as soybits for baking in food products.

18. A product made in accordance with the method of claim 1, wherein the soybeans that have been soaked in cold water, heated and cooled are milled to a small particle size to be used as a flour like product for bakery and food products.

19. The product as recited in claim 18, wherein the particle size and a substantial portion of the soybean product is in a particle size range from 400 microns to 50 microns.
